(19) United States
(12) Patent Application Publication
(10) Pub. No.: US 2003/0057782 A1
(43) Pub. Date: Mar. 27, 2003

(54) AC generator-motor apparatus for vehicle

(75) Inventor: Shin Kusase, Oobu-shi (JP)

Correspondence Address: OLIFF & BERRIDGE, PLC, P.O. BOX 19928, ALEXANDRIA, VA, 22320, US

(73) Assignee: DENSO CORPORATION, Kariya-City (JP)

(21) Appl. No.: 10/214,319

(22) Filed: Aug. 8, 2002

(30) Foreign Application Priority Data
Sep. 21, 2001 (JP) 2001-288505

(51) Int. Cl. H02K 21/00

(52) U.S. Cl. 310/68 D

(57) ABSTRACT

An on-vehicle AC generator-motor apparatus is equipped with a rotor having field poles, an armature, and an AC-DC power converter. The armature is provided with an armature core disposed to face the rotor and three-phase windings wound in slots formed in the armature core. The AC-DC power converter is electrically connected to both of the three-phase windings and a battery of a vehicle. The AC generator-motor apparatus is operated as a motor in cases where an output voltage produced by making the rectifiers rectify an electromotive force generated by the multi-phase windings is higher than a terminal voltage of the battery. The number of slots is set to two per phase at the armature correspondingly to each pole of the field poles. Heat generation from the field poles can be reduced to prevent magnetomotive forces at the field poles from being weakened.

### BACKGROUND OF THE INVENTION

1. Technical Field of the Invention

The present invention relates to an AC (alternating current) generator-motor apparatus mounted on a vehicle to perform operations as both a generator and a motor.

2. Description of Prior Art

A recent technical trend in generators for vehicles is that a generator is given the function of a motor. If such a function is given, the generator is able to work, in addition to a generator, a starter for vehicles or a device to assist the power required for a vehicle when the vehicle runs as higher speeds.

A conventional AC on-vehicle generator operates to produce a large amount of current when it rotates at higher speeds, but the generator supplies an output of which power factor is zero, in which current mainly consists of d-axis current and there is little q-axis current. The lower a speed at which such a generator rotates, the higher the rate of the q-axis current. But, in such a case, the AC on-vehicle generator outputs less current at a lower frequency, resulting in that an increase in magnetic loss on account of q-axis current will not pose so serious problems.

On the other hand, an on-vehicle generator also operating as a starter is forced to have a large amount of q-axis current to start the engine. In this case, because the frequency of the current is low, the q-axis current generates less eddy current, thereby no serious problems being caused by magnetic loss due to the eddy current.

However, the above on-vehicle AC generator is used to assist the travel of the vehicle when the generator is driven at a higher rotation speed, the q-axis current should be increased to produce electrically driven torque at an higher rotation range of the generator, that is, the vehicle. As the q-axis current increases, the magnetic loss of field poles, which are formed into massive poles, is obliged to increase responsively, thus generating heat there at. This will lead to a rise in the resistance of filed windings, with the result that current passing through the windings is lowered largely or the output runs short because of a large decrease in field magnetic force. This shortage occurs, as one reason, from high-temperature degauss of magnets placed between the field poles. Particularly, a two-phase current supply technique, that is, 120-degrees current supply technique, shows a greater amount of generated heat more than the above, thus the foregoing output shortage becoming more serious.

### SUMMARY OF THE INVENTION

The present invention has been performed in consideration of the above-described drawbacks, and an object of the present invention is to provide an on-vehicle AC generator-motor apparatus capable of reduce heat generated from field poles to prevent magnetomotive forces at the field poles from being weakened, so that an output when being operated as a motor is increased and thermal reliability is secured.

In order to realize the above object, the present invention provides an on-vehicle AC generator-motor apparatus comprising a rotor having field ports, an armature, an AC-DC power converter, and a control unit. The armature has not only an armature core arranged so as to be opposed to the rotor but also multi-phase windings individually wound in slots formed in the armature core. The number of slots is two or more per phase at the armature correspondingly to each pole of the field poles. The AC-DC power converter including rectifiers and switching means both electrically connected to the multi-phase windings and an electrical energy source. The control unit is configured to allow the AC generator-motor apparatus to operate as a motor in a faster rotation range of the rotor in which an output voltage produced by making the rectifiers rectify an electromotive force generated by the multi-phase windings is higher than a terminal voltage of the electrical energy source.

Setting the number of slots to two or more per phase at the armature correspondingly to one pole of the field poles makes it possible that, even if the q-axis current is increased to yield torque in the faster rotation range of the rotor, magnetomotive forces induced at rotor-facing tooth formed between the slots of the armature core are lessened.

For example, when the foregoing number of slots per one phase is determined as being two, the magnetomotive forces induced at the teeth of the armature core reduce to ½ of magnetomotive forces induced when the number of slots is one. Accordingly, eddy current induced on the surface of thereabouts of the field poles of the rotor, which is caused due to the magnetomotive forces at the teeth, can be diminished substantially. This makes it possible that heat generation on account of the eddy current is reduced and a decrease in the magnetomotive forces for fields is suppressed. As a result, when the AC generator-motor is operated as a motor in the faster rotation range of the rotor, the output is increased and the thermal reliability is secured.

Preferably, the number of phases of the multi-phase windings is three and the control unit is configured to allow the AC generator-motor apparatus to operate as the motor by supplying current to windings assigned by turns to two phases among the three-phase windings (that is, two-phase current supply). This two-phase current supply permits the armature core to generate magnetomotive forces of which amounts are larger than those based on the conventional three-phase current supply technique. In addition, as described above, because the magnetomotive force induced at each tooth of the armature core is lessened largely, both of the rise and the fall of a drive pulsed current can be made sharper when being operated as a motor. This sharper rise and fall contributes to a greater drive torque.

The magnetomotive forces themselves produced by the armature therefore become larger, while magnetomotive forces provided from the teeth of the armature core to the surfaces of the field poles are dispersed, compared to the configuration in which the number of such slots is one. Hence, the magnetomotive forces directly affecting magnetic loss can be diminished greatly. Even when the two-phase current supply technique is adopted, the heat generation at the surface of the field poles can be suppressed to avid high-temperature degauss of magnets from being generated. It is therefore possible that electrically driven torque is increased in the faster rotation range of the rotor.

### BRIEF DESCRIPTION OF THE DRAWINGS

In the accompanying drawings:

FIG. 1 is a development showing in partial section an essential part of an on-vehicle AC generator-motor apparatus according to one embodiment of the present invention;

FIG. 2 shows a wiring diagram of the AC generator-motor apparatus;

FIG. 3 shows a magnetic distribution obtained when the AC generator-motor apparatus is operated as a motor by two-phase current supply;

FIG. 4 is a timing chart exemplifying how to supply current under the two-phase current supply;

FIG. 5 is a development showing in partial section an essential part of a conventional on-vehicle AC generator-motor apparatus;

FIG. 6 shows a wiring diagram of the conventional AC generator-motor apparatus;

FIG. 7 shows a magnetic distribution obtained when the conventional AC generator-motor apparatus is operated as a motor by three-phase current supply;

FIG. 8 is a timing chart exemplifying how to supply current under the three-phase current supply; and

FIG. 9 shows a magnetic distribution obtained when the conventional AC generator-motor apparatus is operated as a motor by two-phase current supply.

### DETAILED DESCRIPTION OF PREFERRED EMBODIMENTS

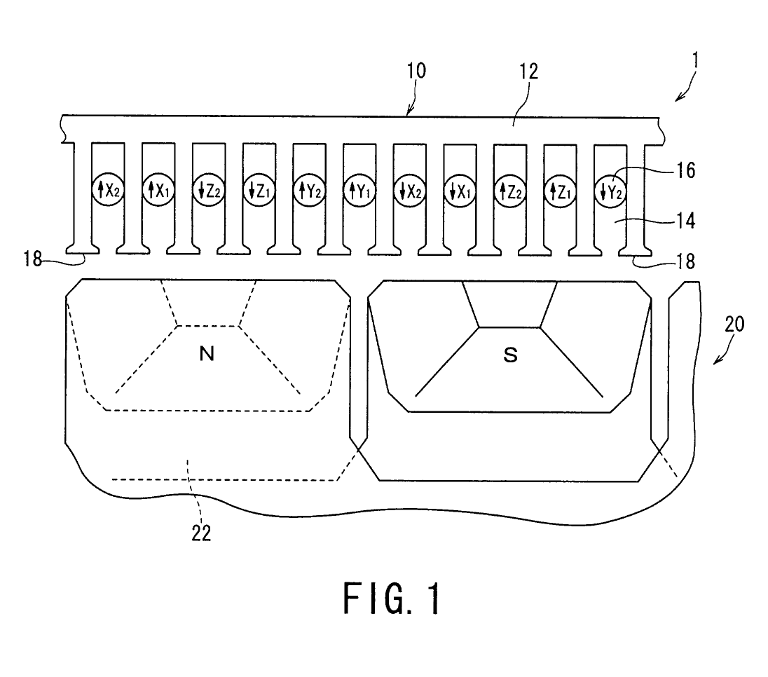

Referring to FIGS. 1 to 9, one embodiment of an on-vehicle AC generator-motor apparatus according to the present invention will now be described.

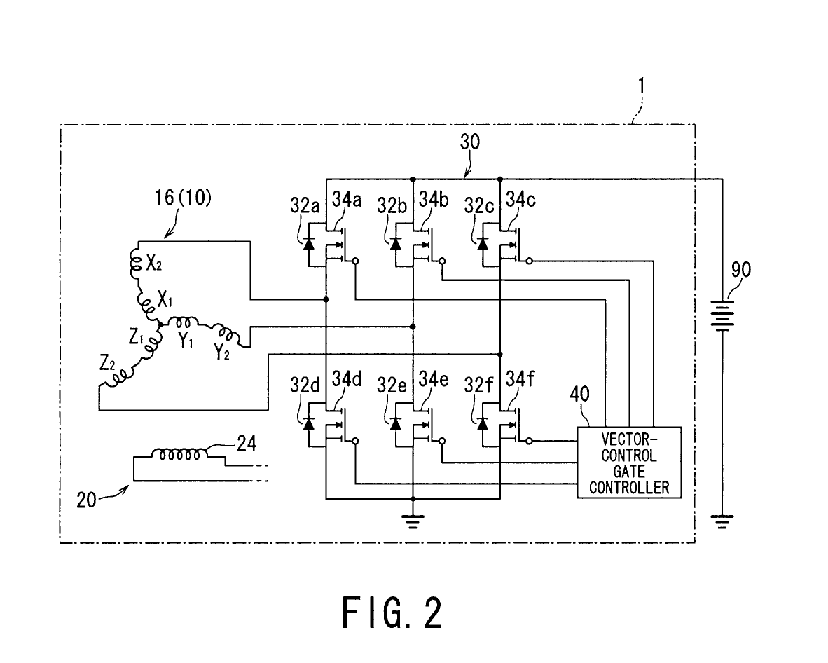

FIG. 1 shows a partial development of an essential-part sectional structure of the on-vehicle AC generator-motor apparatus 1 according to the present embodiment and FIG. 2 is a wiring diagram of wire connections in the on-vehicle AC generator-motor apparatus 1.

As shown in FIGS. 1 and 2, the on-vehicle AC generator-motor apparatus 1 has an armature 10 and a rotor 20. The armature 10 is equipped with an armature core 12 in which pluralities of slots 14 are formed. Along the slots, three-phase windings 16 serving as multi-phase windings are wound. Meanwhile the rotor 20 is provided with Rundel type of field poles 22 and a field winding 24. The field poles 22 are shaped into massive form, respectively, and consist of 16 poles in total, including N-poles and S-poles. A rotor 20 is supported by a frame (not shown) so that the rotor 20 is rotatable, while the armature 10 is supported around the rotator 20 with a predetermined length of a gap apart.

The three-phase windings 16 are composed of an X-phase winding consisting of an X₁ winding and an X₂ winding, a Y-phase winding consisting of a Y₁ winding and a Y₂ winding, and a Z-phase winding consisting of a Z₁ winding and a Z₂ winding. As shown in FIG. 1, the X₁ and X₂ windings composing the X-phase winding are contained in two slots 14 adjacently formed on the armature core 12. Each of the Y- and Z-phase windings is also provided in the same manner as the X-winding. In the present embodiment, the slots 14 assigned to each of the three phases, which are wound by the windings 16, is two in number per pole of the field poles 22.

In FIG. 1, upward arrows and downward arrows attached to the three-phase windings 16 are indicative of the winding directions thereof. This means that the supply of in-phase current to each phase winding will cause current to flow through each phase winding along each of the arrow directions shown in FIG. 1.

In addition, as shown in FIG. 2, the on-vehicle AC generator-motor apparatus 1 includes an AC-DC power converter 30 and a vector-control gate controller 40 serving as a control unit of the present invention. The converter 30 is configured to have six diodes 32a to 32f and six transistors 34a to 34f each functioning as switching means, in which each diode 32a (to 32f) is electrically connected in parallel to each transistor 34a (to 34f). The vector-control gate controller 40 is provided to control on/off timing for each of the transistors 34a to 34f included in the converter 30. By way of example, the transistors 34a to 34f, each made by a power MOSFET, are connected to the controller 40. A battery 90, serving as an electrical energy source, of which terminal voltage is set to 36 volts is connected to the AC-DC power converter 30.

In cases where the on-vehicle AC generator-motor apparatus 1 is operated as a motor, the vector-control gate controller 40 supplies current to only windings for two phases, selected from among the three-phase windings 16, which are located correspondingly to the d-axis of the field poles 22. To realize this two-phase current supply, the controller 40 controls the on/off states of the transistors 34a to 34f detects the position of the rotor 20 while it detects the position of the rotor 20 (that is, the rotation angle of the field poles 22). By way of example, detecting the position of the rotor 20 is carried out by the aid of an output of a hall element secured to the inner circumferential wall or thereabout of the armature core 12. Of course, other techniques for such detection may be employed. By contrast, in cases where the on-vehicle AC generator-motor apparatus 1 is operated as a generator, the controller 40 operates so as to turn off all the transistors 34a to 34f, if making use of the simplest control manner. In this situation, AC (alternating current) voltage induced through the three-phase windings 16 of the armature 10 is rectified by the three-phase full-wave rectifier composed of the six diodes 32a to 32f, so that the voltage is converted into a DC (direct current) voltage.

The foregoing rotor 20 is connected with a vehicle engine (not shown) via a belt at, for example, a pulley rate of 3. Accordingly, if the on-vehicle AC generator-motor apparatus 1 is operated as a generator, the rotor 20 is speeded up to a rotation number three times that of the engine and driven at the speed-up rotation number. In contrast, when the on-vehicle AC generator-motor apparatus 1 is operated as a motor, the rotor 20 is forced to rotate at a rotation number as many as one-third of that of the engine.

The three-phase windings 16 wound in the armature 10 are composed of four conductors per one slot for one phase, so that the number of conductors connected in series through all the poles assigned to one phase is determined as being 128. This configuration of the conductors allows the on-vehicle AC generator-motor apparatus 1 to have, for example, a rising rotation number of approximately 1300 rpm in working as a generator. When the rotation number of the apparatus 1 exceeds this reference rotation number, the AC-DC power converter 30 is designed so that an output voltage (inductive electromotive force) becomes also larger than the battery voltage.

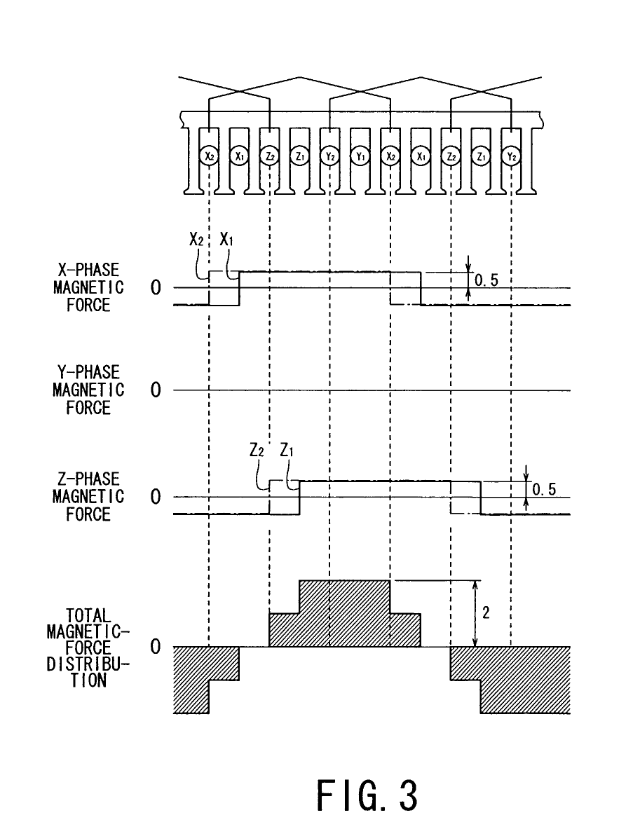

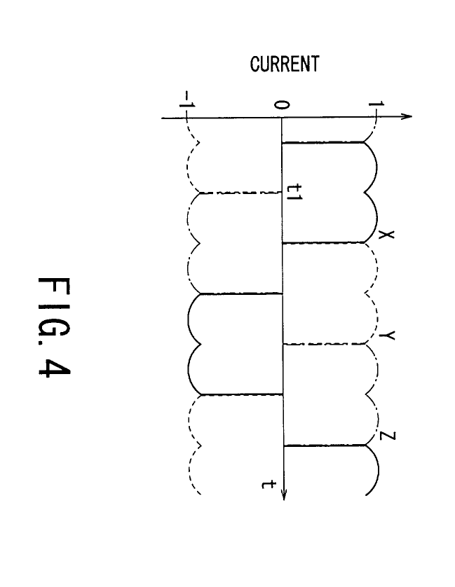

FIG. 3 shows a magnetic distribution obtained when the on-vehicle AC generator-motor apparatus 1 is operated as a motor by using a two-phase current supply technique. FIG. 4 is a timing chart exemplifying two-phase current supply.

In FIG. 4, solid lines indicate current supply timing assigned to the X-phase winding (the X₁ and X₂ windings as shown in FIG. 2). Similarly, dotted lines indicate current supply timing assigned to the Y-phase winding (the Y₁ and Y₂ windings as shown in FIG. 2), and one-dotted lines indicate current supply timing assigned to the Z-phase winding (the Z₁ and Z₂ windings as shown in FIG. 2). As clear from FIG. 4, supplying current each winding by turns at a phase difference of 120 degrees will lead to the two-phase current supply. The magnetic distribution shown in FIG. 3 is established in the current supply state realized at a time instant slightly passing a time t₁ shown in FIG. 4.

To be specific, in FIG. 4, a positive peak current value is noted by “+1,” while the negative peak one, which shows the opposite direction to the positive one, is noted by “−1.” Therefore, as understood from FIG. 4, at a time instant slightly passing the time t₁, current close to a positive peak current flows through the X-phase winding and current close to a negative peak current flows through the Z-phase winding, but no current flows through the Y-phase winding. This way of supplying currents permits magnetomotive forces to arise only at both the X-phase winding (the X₁ and X₂ windings) and the Z-phase winding (the Z₁ and Z₂ windings). The total magnetic force distribution can be given by summing up both of the magnetomotive forces.

When the engine is started up, the on-vehicle AC generator-motor apparatus 1 acts as a starting motor. Practically, the vector-control gate controller 40 controls the on/off timing for the transistors 34a to 34f of the AC-DC power converter 30 in such a manner that the q-axis current can flow. Responsively to this current supply, in the on-vehicle AC generator-motor apparatus 1, a torque is generated at the rotor 20 in response to the electric drive, and the torque drives the engine so that it rotates under a reduction gear ratio of 3. After the engine begins its self-supporting rotation, the AC generator-motor apparatus 1 maintains a rotation number more than 1300 rpm. If this self-supporting rotation has been realized, the vector-control gate controller 40 operates to turn off the transistors 34a to 34f of the AC-DC power converter 30, so that the apparatus 1 is permitted to act a generator this time. The AC voltage outputted by the three-phase windings 16 of the armature is rectified by the diodes 32a to 32f of the converter 30 into DC voltage of which amplitude is higher than the battery voltage. Such DC voltage is used for charging the battery 90 and supplying power to other electric loads (not shown).

When the vehicle is accelerated in speed, as is often in passing other vehicles in a highway, the rotation number of the AC generator-motor apparatus 1 often reaches a range of faster rotation numbers over a predetermined one. That is, for example, such a range of rotation numbers is higher than a rotation of 5000 rpm that is a rating speed to the generator. If such a situation is realized, the vector-control gate controller 40 performs the control so that the generator-motor apparatus 1 serves as a motor for assisting the run of the vehicle. Specifically, the controller 40 controls the on/off timing of the transistors 34a to 34f in such a manner that only arbitrary windings for the two phases selected from among the three-phase windings 16 are subjected to current supply and a synthesized magnetomotive force yielded at the armature is a maximum in the q-axis direction of the Rundel type of magnetic poles 22. If the supply of a fundamental-wave current supply is done at 670 Hz when the rotor 20 is rotated at a rotation number more than 5000 rpm, the control of the two-phase current supply makes it possible to produce a fast rotating magnetic filed of 83 rev/s by the use of 16 poles, thus generating torque responsively to the electric drive.

As described above, in the generator-motor apparatus 1 according to the present embodiment, the number of slots is set to two per phase at the armature 10 correspondingly to one pole of the field poles 22. Hence a magnetomotive force induced at each tooth 18, which is formed between adjacent slots of the armature core 12 so as to face to the rotor 20, is reduced down to approximately half of a magnetomotive force gained by a conventional configuration in which the number of such slots is set to one. As a result, eddy current induced on the surface or thereabouts of the field poles 22 of the rotor 20, owing to the magnetomotive force generating at each tooth 18, can be lowered largely. Responsively, heat generation due to the eddy current can also be reduced, while the magnetomotive force for the filed can be prevented from being lowered. This makes it possible to raise the output gained when the rotor is rotated at higher speeds during the operation as the motor as well as to secure thermal reliability.

Furthermore, in the case of the generator-motor apparatus 1 described in the present embodiment, the motor operation performed when the rotor 20 rotates at a certain speed belonging to a range of higher speeds is attained by supplying current to two-phase windings. Thus, the magnetomotive force to be generated at the armature core 12 is made to be “3½/1.5 times” in comparison with that given by the conventional three-phase current supply technique. In other words, the magnetomotive force that gives electrically driven toque to one pole among the field poles 22 can be raised about 15 percents. Despite the fact that the magnetomotive force generated from the armature 10 has been increased by itself, magnetomotive force given from each tooth 18 of the armature core 12 to the surfaces of the field poles 22 is dispersed to half of an amount gained by a system where the number of slots is set to one. The magnitude of the magnetomotive force that directly influences magnetic loss is, compared to the conventional one, “3½/1.5/2” times, or being reduced to approximately to 57 percents. Therefore, using even the two-phase current supply will lead to a suppressed heat generation on the surfaces of the filed poles 22, so that the high-temperature degauss of magnets can be avoided. Hence it is possible to raise the electrically driven torque in the range of higher speeds.

As a practical case, using a vehicle on which a 3000-cc class of engine and a 3-kW class of on-vehicle AC generator-motor apparatus are mounted, comparative tests were conducted between the conventional AC generator-motor apparatus and the AC generator-motor apparatus 1 according to the present embodiment. The tests showed that the electrically driven torque improved from 10 Nm to 12 Nm, by 20 percents, and the surface temperature on the filed poles 22 was lowered from 220° C. to 100° C. at a rotation of 7500 rpm, which is nearly the speed of passing other vehicles in a highway, at which the AC generator-motor apparatus is rotated.

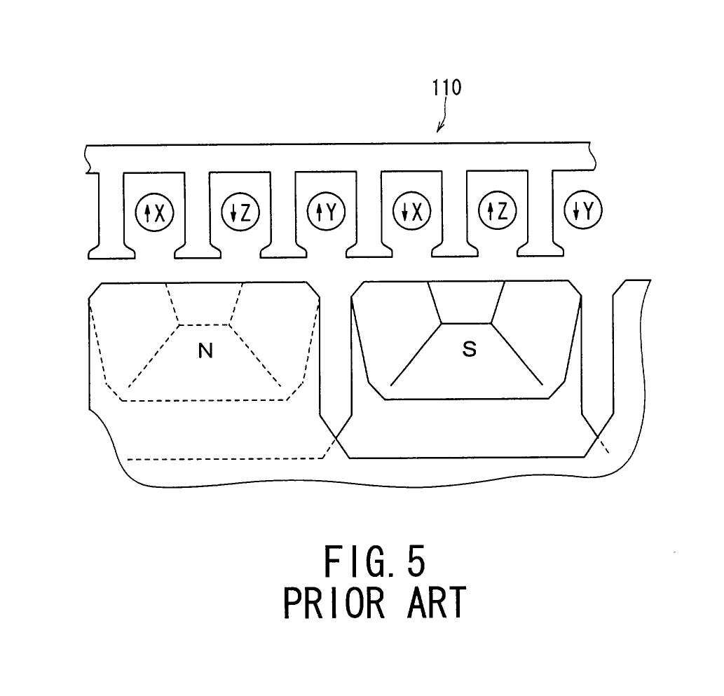

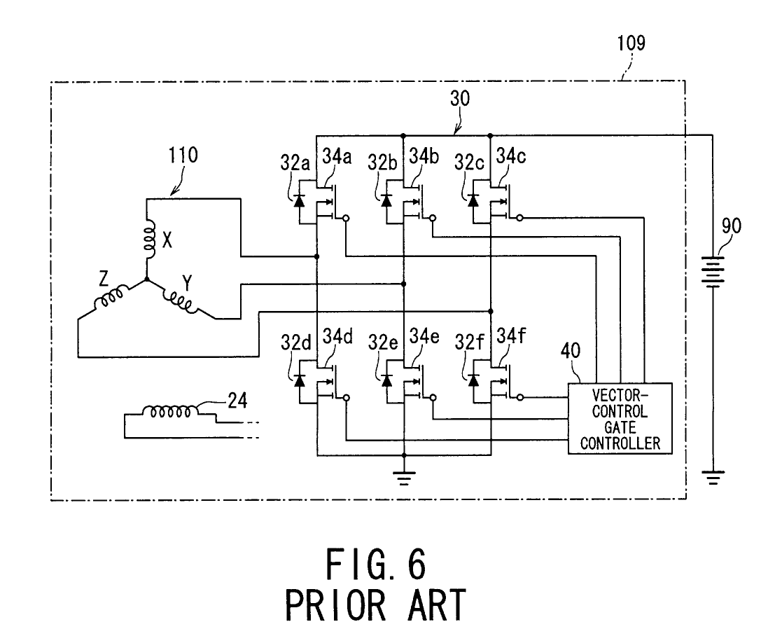

FIG. 5, which was adopted for comparison, shows a development of an essential cross sectional structure of the conventional on-vehicle generator-motor apparatus. FIG. 5 is a wiring diagram of the on-vehicle generator-motor apparatus shown in FIG. 6. As can be understood from FIG. 5, the conventional AC generator-motor apparatus is configured to have a single slot per phase of an armature 110, which corresponds to one pole of filed poles. As shown FIG. 6, the configuration other than the armature 110 is the same as that shown in FIGS. 1 and 2, where the vector-control gate controller 40 is able to control the generator-motor apparatus so as to work as a motor.

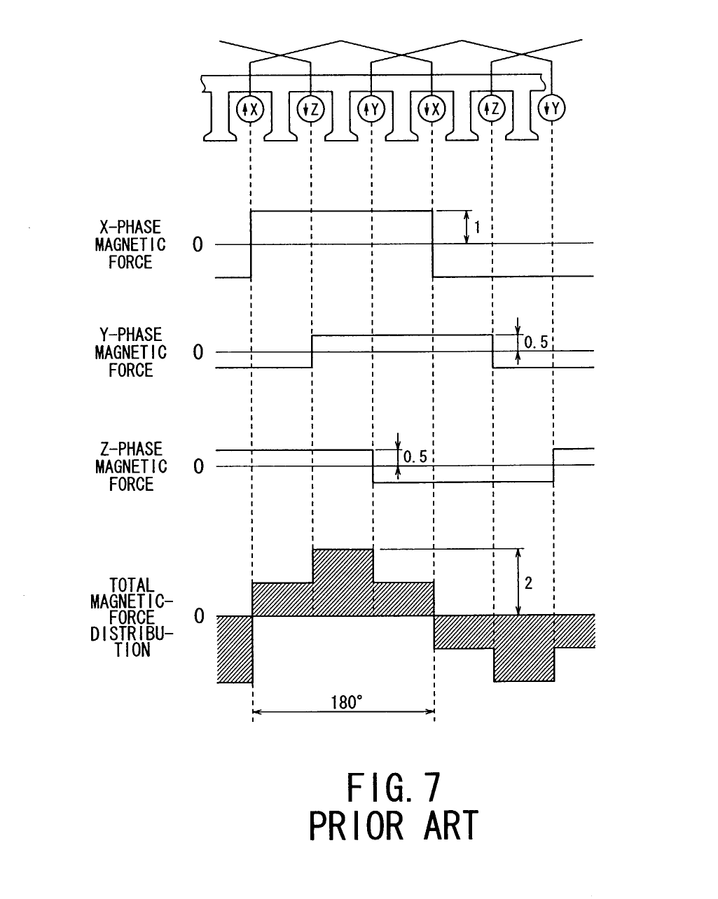

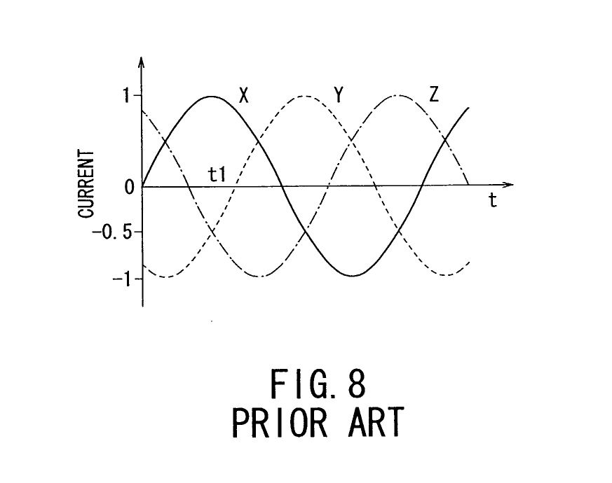

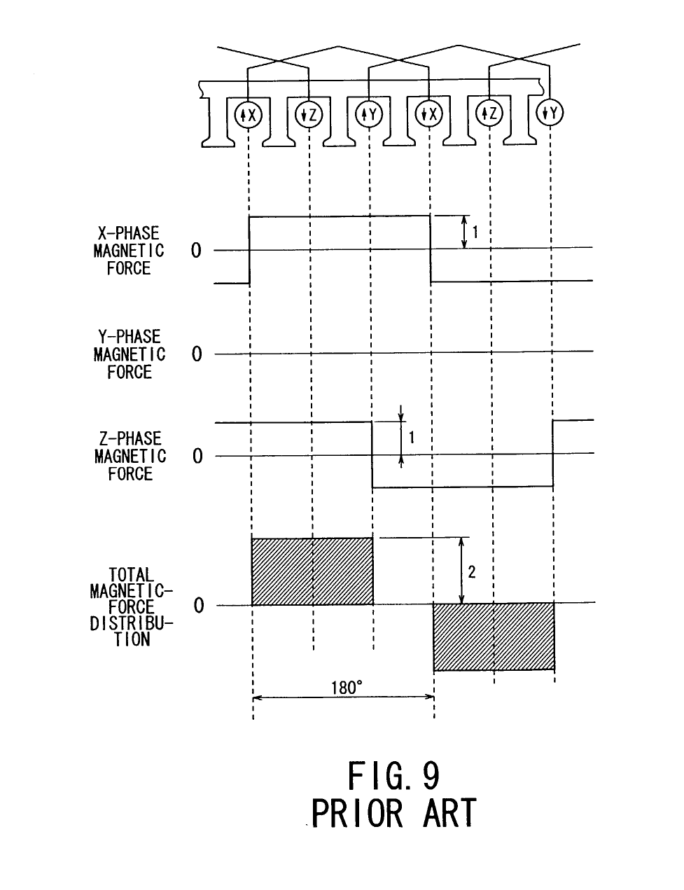

FIG. 7 shows a magnetic force distribution obtained when the conventional AC generator-motor apparatus shown in FIGS. 5 and 6 is operated as a motor with the use of the three-phase current supply technique. A practical timing chart for the three-phase current supply is exemplified in FIG. 8. In addition, FIG. 9 depicts a magnetic force distribution, which is obtained by performing two-phase current supply toward the conventional AC generator-motor apparatus shown in FIGS. 5 and 6, in cases where the apparatus is made to work as a motor. Even when the conventional apparatus is operated using the two-phase current supply technique, magnetomotive forces generated by the three-phase windings of the armature may be made larger than that obtained under the three-phase current supply. However, as shown in FIG. 9, at a phase corresponding to ⅔ of an electrical angle of 180 degrees, a large magnetomotive force acts on the field poles, with the result that eddy current to be generated on the surface of the field poles is enhanced more largely. This will lead to an excessive rise in temperature. By contrast, such an excessive rise in temperature can be solved the on-vehicle AC generator-motor apparatus 1 configured according to the present embodiment.

The present invention is not restricted to the constructions shown in the foregoing embodiments, but a person having ordinary skill in the art can create a variety of constructions adequately altered or deformed within the scope of the claims. For example, though the foregoing embodiment has explained the two-phase current supply in 120 degrees, the three-phase current supply in 180 degrees may be done. In this case, setting the number of slots 14 to two per one phase of the armature 10 correspondingly to one pole of the field poles 22 also makes it possible to disperse the magnetomotive force, which is attributable to magnetic loss caused on the surface of the field poles 22. The magnetomotive force of the armature given to the surface of the poles can be reduced largely, because the eddy currents thereon are lessened in total.

In addition, the foregoing embodiment has adopted the three-phase windings 16 as multi-phase windings, but this is not a definitive list. For example, multi-phase windings other than the three-phase windings can be employed. On the other hand, the number of filed poles 22 given to the rotor 20 can be modified as well. By way of example, the number of poles may be set to any total number other than 16, including N and S poles.

What is claimed is:

1. An on-vehicle AC generator-motor apparatus comprising:
a rotor having field ports;
an armature having not only an armature core arranged so as to be opposed to the rotor but also multi-phase windings individually wound in slots formed in the armature core, the number of slots being two or more per phase at the armature correspondingly to each pole of the field poles;
an AC-DC power converter including rectifiers and switching means both electrically connected to the multi-phase windings and an electrical energy source; and
a control unit for allowing the AC generator-motor apparatus to operate as a motor in a faster rotation range of the rotor in which an output voltage produced by making the rectifiers rectify an electromotive force generated by the multi-phase windings is higher than a terminal voltage of the electrical energy source.

2. The on-vehicle AC generator-motor apparatus according to claim 1, wherein the number of phases of the multi-phase windings is three and the control unit is configured to allow the AC generator-motor apparatus to operate as the motor by supplying current to windings assigned by turns to two phases among the three-phase windings.

3. The on-vehicle AC generator-motor apparatus according to claim 1, wherein the number of slots is two per phase at the armature correspondingly to each pole of the field poles.

4. The on-vehicle AC generator-motor apparatus according to claim 3, wherein the number of phases of the multi-phase windings is three and the control unit is configured to allow the AC generator-motor apparatus to operate as the motor by supplying current to windings assigned by turns to two phases among the three-phase windings.

5. The on-vehicle AC generator-motor apparatus according to claim 1, wherein the electrical energy source is a battery mounted in a vehicle in which the AC generator-motor apparatus is mounted.
